(19) United States
(12) Patent Application Publication
(10) Pub. No.: US 2024/0123612 A1
(43) Pub. Date: Apr. 18, 2024

(54) MOBILE MANIPULATOR AND METHOD OF CONTROLLING THE SAME

(71) Applicant: ELECTRONICS AND TELECOMMUNICATIONS RESEARCH INSTITUTE, Daejeon (KR)

(72) Inventors: Wookyong KWON, Daejeon (KR); Yongsik JIN, Daejeon (KR); Dongyeop KANG, Daejeon (KR); Seung Woo NAM, Daejeon (KR); Jeyoun DONG, Daejeon (KR)

(73) Assignee: ELECTRONICS AND TELECOMMUNICATIONS RESEARCH INSTITUTE, Daejeon (KR)

(21) Appl. No.: 18/170,923

(22) Filed: Feb. 17, 2023

(30) Foreign Application Priority Data
Oct. 17, 2022 (KR) 10-2022-0133134

(51) Int. Cl. B25J 9/16; B25J 5/00; B25J 9/00; B25J 19/00

(52) U.S. Cl. CPC B25J 9/161; B25J 5/007; B25J 9/0009; B25J 19/002

(57) ABSTRACT

Provided is a mobile manipulator for performing a target motion, which includes a base unit configured to perform a positional shift and having a rail in some section thereof, and an arm unit including multi-joints and configured to perform a positional shift on the rail in consideration of a center of gravity when performing a target motion. The arm unit performs the target motion through adaptive neural network-based compensation control.

### CROSS-REFERENCE TO RELATED APPLICATION

This application claims priority to and the benefit of Korean Patent Application No. 10-2022-0133134, filed on Oct. 17, 2022, the disclosure of which is incorporated herein by reference in its entirety.

### BACKGROUND

### 1. Field of the Invention

The present invention relates to a mobile manipulator and a method of controlling the same.

### 2. Discussion of Related Art

A mobile manipulator, on which there have been variously studies recently, operates as a combination of a manipulator for work and a mobile robot for movement.

Therefore, unlike existing robot manipulators that work while fixed to the floor, a mobile manipulator may have a wide workspace area and overcome limitations of mobility. As a result, a mobile manipulator may perform various tasks, and the usability may be maximized compared to existing robot manipulators.

However, safety and stability of the mobile manipulator need to be ensured in a process of performing a target motion for a specific task. This is because when a manipulator with an excessive load is mounted on a body of a mobile robot, the balance may be lost and the body may roll over in a process of performing a target motion.

Therefore, in order to properly utilize a mobile manipulator, there is a need to satisfy mechanical flexibility, a light weight, and balance considering a condition of the center of gravity.

### SUMMARY OF THE INVENTION

In order to solve the above problems, the present invention is directed to providing a mobile manipulator and a method of controlling the same that may satisfy mechanical flexibility, a light weight, and balance considering a condition of the center of gravity when performing a target motion.

The technical objectives of the present invention are not limited to the above, and other objectives may become apparent to those of ordinary skill in the art based on the following description.

According to an aspect of the present invention, there is provided a mobile manipulator including: a base unit configured to perform a positional shift and having a rail in some section thereof; and an arm unit including multi-joints and configured to perform a positional shift on the rail in consideration of a center of gravity when performing a target motion, wherein the arm unit performs the target motion through adaptive neural network-based compensation control.

The arm unit may estimate disturbance in a form of a radial basis function neural network (RBF-NN) to correct a real-time position.

The arm unit may perform positional shift by a preset interval in a length direction of the rail.

The arm unit may perform positional shift in a length direction of the rail, wherein the arm unit may be fixed by a separate stopper disposed at each preset position.

The center of gravity for each position of the arm unit may be adjusted according to a shape and/or a length of the arm unit in consideration of a payload.

The base unit may be configured to adjust the center of gravity for each position of the arm unit according to a shape and/or a length of the multi-joint of the arm unit in consideration of a payload of the arm unit.

The base unit may be provided at each section with a weight block corresponding to a payload of the arm unit.

The base unit may be provided with a weight block corresponding to a payload of the arm unit to move the weight block according to a shift of the arm unit to each position such that weight balance may be maintained.

The base unit may include: a housing having an accommodation space therein and an upper end connected to the rail; and a moving device connected to a lower end of the housing.

The rail may be attachable to and detachable from the housing.

According to another aspect of the present invention, there is provided a mobile manipulator including: a base unit configured to perform a positional shift; an arm unit configured to perform a positional shift in some section of the base unit; and a control unit configured to control driving of the base unit and the arm unit.

The control unit may control a target motion of the arm unit through adaptive neural network-based compensation control in consideration of a payload of the arm unit.

The control unit may estimate disturbance in a form of radial basis function neural Network (RBF-NN) to correct a real-time position of the arm unit.

The arm unit may have a multi joint structure divided into an inner module and an outer cover.

The outer cover of the arm unit may be coupled to the inner module in a snap-fit manner.

In the base unit, a weight block corresponding to a payload of the arm unit may be embedded in a longitudinal end thereof.

According to another aspect of the present invention, there is provided a method of controlling a mobile manipulator, the method including: setting a target motion of a mobile manipulator including a base unit provided to be movable and an arm unit including a multi-joint and configured to perform a positional shift on an upper end of the base unit; and controlling the target motion of the mobile manipulator.

The controlling of the target motion of the mobile manipulator may include performing a target motion of the arm unit through adaptive neural network-based compensation control.

The controlling of the target motion of the mobile manipulator may include estimating disturbance in a form of radial basis function neural Network (RBF-NN) to correct a real-time position of the arm unit.

The controlling of the target motion of the mobile manipulator may include adjusting a center of gravity for each position of the mobile manipulator according to a shape and/or a length of the arm unit.

The setting of the target motion of the mobile manipulator may include setting a target motion of the mobile manipulator in consideration of a payload of the arm unit and a condition of a center of gravity for each position of the arm unit.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view schematically illustrating a mobile manipulator according to an embodiment of the present invention;

FIG. 2 is an exemplary diagram schematically illustrating an operating mechanism of a mobile manipulator according to an embodiment of the present invention;

FIG. 3 is an exemplary block diagram schematically illustrating a method of controlling a mobile manipulator according to an embodiment of the present invention;

FIG. 4 is a block diagram illustrating a computer system for implementing a method of controlling a mobile manipulator according to an embodiment of the present invention; and

FIG. 5 is an operation flowchart showing a method of controlling a mobile manipulator according to an embodiment of the present invention.

### DETAILED DESCRIPTION OF EXEMPLARY EMBODIMENTS

Hereinafter, the advantages and features of the present invention and ways of achieving them will become readily apparent with reference to the following embodiments described in detail in conjunction with the accompanying drawings. However, the present invention is not limited to such embodiments and may be embodied in various forms. The embodiments to be described below are provided only to make the disclosure of the present invention complete and assist those of ordinary skill in the art in fully understanding the scope of the present invention, and the scope of the present invention is defined only by the appended claims. Terms used herein are used for describing the embodiments and are not intended to limit the scope and spirit of the present invention. It should be understood that the singular forms “a” and “an” in addition include the plural forms unless the context clearly dictates otherwise. The terms “comprises,” “comprising,” “includes,” and/or “including,” when used herein, specify the presence of stated features, integers, steps, operations, elements, components and/or groups thereof and do not preclude the presence or addition of one or more other features, integers, steps, operations, elements, components, and/or groups thereof. As used in the specification, the term “and/or” includes any one or combinations of the associated listed items.

Hereinafter, exemplary embodiments of the present invention will be described in detail with reference to the accompanying drawings.

Mobile Manipulator

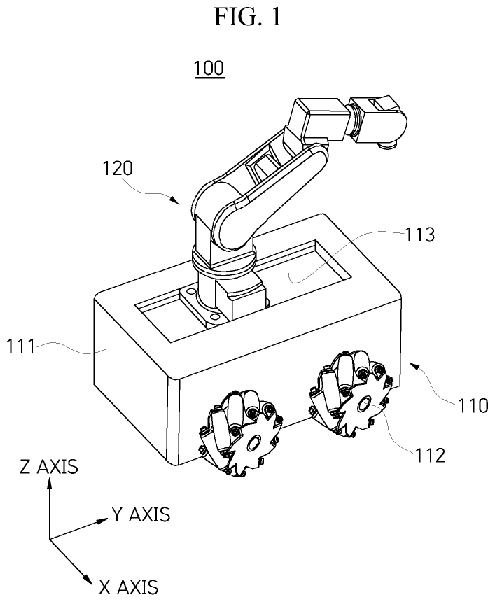

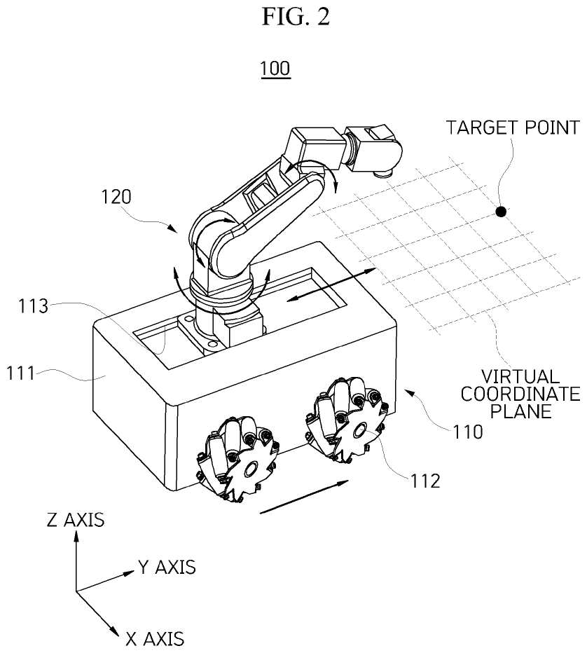

FIGS. 1 and 2 illustrate a mobile manipulator according to an embodiment of the present invention.

A mobile manipulator 100 may be driven by a command through a separate control or may autonomously travel along a target trajectory to a target point by a preset command.

The mobile manipulator 100 includes a base unit 110 and an arm unit 120.

The base unit 110 is a movable object for performing positional shift. The base unit 110 includes a housing 111, a moving device 112, and a rail 113.

The housing 111 has an accommodation space therein. The accommodation space of the housing 111 contains components related to electronic parts.

The moving device 112 is connected to a lower end of the housing 111. The moving device 112 may be provided as an omni-directionally movable wheel or a caterpillar (an endless track).

The rail 113 is positioned in a section of an upper end of the housing 111. Although not shown, the rail 113 may be implemented in various forms without being limited to the corresponding position. For example, the rail 113 may be formed in a perimeter of the housing 111 and/or an inclined form of which the height is adjustable.

The rail 113 may be provided to be attachable to and detachable from the housing 111 to resolve durability issues.

The arm unit 120 is a multi joint assembly type robot arm having links connected to each other, and includes a plurality of rotational joints to perform a target motion. The arm unit 120 is configured to receive power and communication signals through a connection unit of each link and change a rotating direction of a motor such that each joint is moved through gears and a rotating plate.

Here, depending on connection of each joint, the shape of a workspace of the arm unit 120 is changed. In this case, the workspace refers to an area that an end-effector may reach.

The arm unit 120 may perform positional shift on the rail 113 in consideration of the center of gravity when performing a target motion. Since the arm unit 120 is movable on the rail 113, the mobile manipulator 100 may have an additional degree of freedom.

The arm unit 120 may perform a target motion through adaptive neural network-based compensation control.

Since the arm unit 120 shifts positions while being connected to an upper part of the base unit 110 including a movable object, the arm unit 12 is configured in a compact and lightweight form. Here, the criterion for lightweight may be the degree to which the load of the arm unit 120 does not affect the stability of the base unit 110.

In addition, a payload for balance needs to be considered for the arm unit 120. Accordingly, the arm unit 120 may adjust the center of gravity for each position according to the shape and/or length of the arm unit 120 in consideration of a payload. Here, the payload includes the weight of the end-effector mounted on the end tip of the arm unit 120.

The arm unit 120 may perform linear movement in a horizontal and/or vertical direction to perform a task of delivering an object or the like to a relatively high target point.

The arm unit 120 may perform a positional shift by preset intervals along the longitudinal direction of the rail 113 (positive and negative directions of the Y-axis).

In this case, the base unit 110 may adjust the center of gravity for each position of the arm unit 120 according to the shape and/or length of the multi joint of the arm unit 120 in consideration of the payload of the arm unit 120.

For example, when the arm unit 120 moves along the rail 113 toward a target point on a target trajectory, the position of the center of gravity of the arm unit 120 may be adjusted in real time by a plurality of weight blocks (not shown) that are located in the vicinity of the rail 113 at intervals of points (at each section),

Here, the base unit 110 may serve to maintain a weight balance by changing the position of the weight block corresponding to the payload of the arm unit 120 in conjunction with a shift of the arm unit 120 to each position.

In the base unit 110, a weight block corresponding to the payload of the arm unit 120 may be embedded in an end portion in the longitudinal direction (positive and negative directions of the Y-axis).

When the arm unit 120 is shifted along the length direction of the rail 113 (positive and negative directions of the Y axis), the arm unit 120 may be fixed by a separate stopper (not shown) and/or a fixing clip (not shown) disposed at each preset position.

The arm unit 120 may have a multi joint structure divided into an inner module (not shown) and an outer cover (not shown). In this case, the outer cover of the arm unit 120 may be provided in a form in which it is coupleable to the inner module in a snap-fit manner.

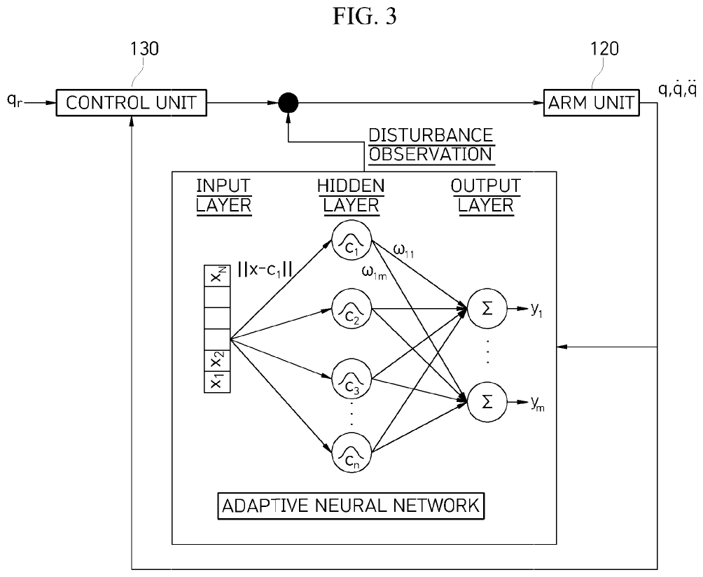

FIG. 3 schematically illustrates a method of controlling a mobile manipulator according to an embodiment of the present invention.

The arm unit 120 may perform a target motion by itself through adaptive neural network-based compensation control, or may be allowed to perform a corresponding operation by a control unit 130.

When the arm unit 120 is configured as a variable type, mechanical and dynamic parameters of each joint are changed according to the configuration, and the control precision may be lowered or vibrations may occur in driving the robot. In order to prevent the constraints, the control unit 130, which does not require individual model information, may be utilized.

The control unit 130 controls the target motion of the arm unit 120 through an adaptive neural network-based compensation control in consideration of the payload of the arm unit 120. The control unit 130 may allow the arm unit 120 to move precisely to a target point or along a target trajectory without model information related to each joint of the arm unit 120. That is, through the control unit 130, the mobile manipulator 100 may perform targeted precise operations, thereby providing an improved trajectory tracking performance.

The control unit 130 estimates a disturbance in the form of a radial basis function neural network (RBF-NN) to correct the real-time position of the arm unit 120.

In estimating the disturbance in the form of an RBF-NN, the adaptive neural network is configured such that a neural network is included in a dynamic equation for the remainder to be estimated and compensated for.

In FIG. 3, q, \grave{q}, \ddot{g} denote a position, a velocity, and an acceleration of a joint, respectively, and qᵣ denotes a target trajectory.

An RBF-NN has an input layer, a hidden layer, and an output layer. The output layer is linear, and there is no weight between the input layer and the hidden layer. The hidden layer uses a radial basis function. Calculation may be performed using a distance measurement method (e.g., by operating based on Euclidean distance measurement data, etc.).

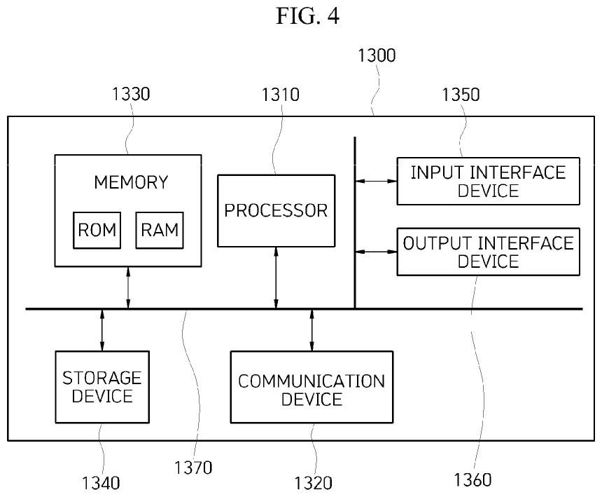

FIG. 4 is a block diagram illustrating a computer system for implementing a method of controlling a mobile manipulator according to an embodiment of the present invention.

Referring to FIG. 4, a computer system 1300 may include at least one of a processor 1310, a memory 1330, an input interface device 1350, an output interface device 1360, and a storage device 1340 that communicate through a bus 1370. The computer system 1300 may further include a communication device 1320 coupled to a network.

The processor 1310 may be a central processing unit (CPU) and/or a graphics processing unit (GPU), or a semiconductor device for executing instructions stored in the memory 1330 and/or storage device 1340.

The processor 1310 may include a CPU, a GPU, a system on chip, a microcontroller unit (MCU), or the like configured to control and manage overall operations of a neural network algorithm shown in FIG. 3.

The memory 1330 and the storage device 1340 may include various forms of volatile or nonvolatile media. For example, the memory 1330 may include a read only memory (ROM) or a random-access memory (RAM). The memory 1330 may be located inside or outside the processor 1310 and may be connected to the processor 1310 through various known means. The memory 1330 may include various forms of volatile or nonvolatile media, for example, may include a ROM or a RAM.

Accordingly, the present invention may be embodied as a method implemented in a computer or non-transitory computer readable media in which computer executable instructions are stored. According to an embodiment, when executed by a processor, computer readable instructions may perform a method according to at least one aspect of the present invention.

The communication device 1320 may transmit or receive a wired signal or a wireless signal.

In addition, the method according to the embodiment of the present invention may be implemented in the form of program instructions executable by various computer devices and may be recorded on computer readable media.

The computer readable media may be provided with program instructions, data files, data structures, or the like alone or as a combination thereof. The program instructions stored in the computer readable media may be specially designed and constructed for the purposes of the present invention or may be well-known and available to those having skill in the art of computer software. The computer readable storage media include hardware devices configured to store and execute program instructions. For example, the computer readable storage media include magnetic media such as hard disks, floppy disks, and magnetic tape, optical media such as a compact disc (CD)-ROM and a digital video disc (DVD), magneto-optical media such as floptical disks, a ROM, a RAM, a flash memory, etc. The program instructions include not only machine language code made by a compiler but also high level code that can be used by an interpreter or the like, which is executed by a computer.

Method of Controlling Mobile Manipulator

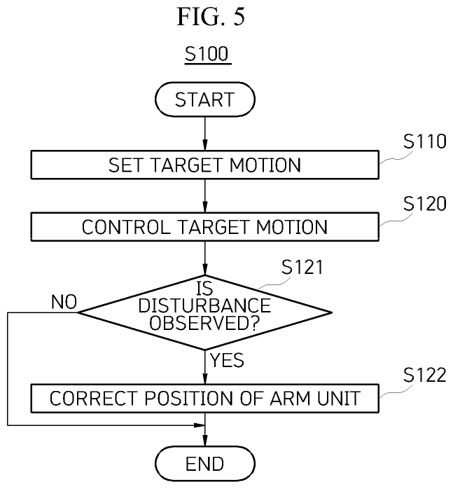

FIG. 5 shows a method of controlling a mobile manipulator according to an embodiment of the present invention. For the sake of convenience of description of FIG. 5, the following description will be made in conjunction with FIGS. 1 to 4.

A method of controlling a mobile manipulator (S100) largely includes setting a target motion (S110) and controlling a target motion (S120).

In the setting of the target motion S110, a target motion of the mobile manipulator 100 including a movable base unit 110 and an arm unit 120 including a multi-joint and configured to perform positional shift on the upper end of the base unit 110 is set.

In the setting of the target motion S110, the target motion may be set in consideration of the payload of the arm unit 120 and the condition of the center of gravity for each position of the arm unit 120.

In the controlling of the target motion S120, the target motion of the mobile manipulator 100 is controlled. In this case, the controlling of the target motion S120 may be performed by the processor 1310 shown in FIG. 4.

In the controlling of the target motion S120, the target motion of the arm unit 120 is performed through adaptive neural network-based compensation control.

In this case, in the controlling of the target motion S120, the disturbance is estimated in the form of an RBF-NN (S121), and the real-time position of the arm unit 120 is corrected (S122).

In the controlling of the target motion (S120), the center of gravity for each position of the mobile manipulator 100 may be adjusted according to the shape and/or length of the arm unit 120.

According to the present invention, mechanical flexibility, lightweight, and balance considering a condition of the center of gravity when performing a target motion are satisfied, and thus the safety and stability can be ensured in a process of performing a target motion for a specific task.

In particular, precise target motions can be performed using adaptive neural network-based compensation control.

Although the present invention has been described with reference to embodiments illustrated in the drawings, the embodiments disclosed above should be construed as being illustrative rather than limiting the present invention, and those skilled in the art should appreciate that various substitutions, modifications, and changes are possible without departing from the scope and spirit of the present invention.

Therefore, the scope of the present invention is defined by the appended claims of the present invention.

What is claimed is:

1. A mobile manipulator for performing a target motion, the mobile manipulator comprising:
a base unit configured to perform a positional shift and having a rail in some section thereof; and
an arm unit including multi-joints and configured to perform a positional shift on the rail in consideration of a center of gravity when performing a target motion,
wherein the arm unit performs the target motion through adaptive neural network-based compensation control.

2. The mobile manipulator of claim 1, wherein the arm unit estimates disturbance in a form of radial basis function neural network (RBF-NN) to correct a real-time position.

3. The mobile manipulator of claim 1, wherein the arm unit is allowed to perform positional shift by a preset interval in a length direction of the rail.

4. The mobile manipulator of claim 1, wherein the arm unit is allowed to perform positional shift in a length direction of the rail, wherein the arm unit is fixed by a separate stopper disposed at each preset position.

5. The mobile manipulator of claim 1, wherein the center of gravity for each position of the arm unit is adjusted according to a shape and/or a length of the arm unit in consideration of a payload.

6. The mobile manipulator of claim 1, wherein the base unit adjusts the center of gravity for each position of the arm unit according to a shape and/or a length of the multi-joint of the arm unit in consideration of a payload of the arm unit.

7. The mobile manipulator of claim 1, wherein the base unit is provided at each section with a weight block corresponding to a payload of the arm unit.

8. The mobile manipulator of claim 1, wherein the base unit is provided with a weight block corresponding to a payload of the arm unit to move the weight block according to a shift of the arm unit to each position such that weight balance is maintained.

9. The mobile manipulator of claim 1, wherein the base unit includes:
a housing having an accommodation space therein and an upper end connected to the rail; and
a moving device connected to a lower end of the housing.

10. The mobile manipulator of claim 9, wherein the rail is attachable to and detachable from the housing.

11. A mobile manipulator comprising:
a base unit configured to perform a positional shift;
an arm unit configured to perform a positional shift in some section of the base unit; and
a control unit configured to control driving of the base unit and the arm unit,
wherein the control unit controls a target motion of the arm unit through adaptive neural network-based compensation control in consideration of a payload of the arm unit.

12. The mobile manipulator of claim 11, wherein the control unit estimates disturbance in a form of radial basis function neural Network (RBF-NN) to correct a real-time position of the arm unit.

13. The mobile manipulator of claim 11, wherein the arm unit has a multi-joint structure divided into an inner module and an outer cover.

14. The mobile manipulator of claim 13, wherein the outer cover of the arm unit is coupleable to the inner module in a snap-fit manner.

15. The mobile manipulator of claim 11, wherein, in the base unit, a weight block corresponding to a payload of the arm unit is embedded in a longitudinal end.

16. A method of controlling a mobile manipulator, the method comprising:
setting a target motion of a mobile manipulator including a base unit provided to be movable and an arm unit including a multi-joint and configured to perform a positional shift on an upper end of the base unit; and
controlling the target motion of the mobile manipulator.

17. The method of claim 16, wherein the controlling of the target motion of the mobile manipulator includes performing a target motion of the arm unit through adaptive neural network-based compensation control.

18. The method of claim 17, wherein the controlling of the target motion of the mobile manipulator includes estimating disturbance in a form of radial basis function neural Network (RBF-NN) to correct a real-time position of the arm unit.

19. The method of claim 16, wherein the controlling of the target motion of the mobile manipulator includes adjusting a center of gravity for each position of the mobile manipulator according to a shape and/or a length of the arm unit.

20. The method of claim 16, wherein the setting of the target motion of the mobile manipulator includes setting a target motion of the mobile manipulator in consideration of a payload of the arm unit and a condition of a center of gravity for each position of the arm unit.
